(19) United States
(12) Patent Application Publication
(10) Pub. No.: US 2008/0152239 A1
(43) Pub. Date: Jun. 26, 2008

(54) Image Compression System

(75) Inventor: Stephen Sadler, Clarkston, MI (US)

Correspondence Address: Philip R. Warn;Warn, Hoffmann, Miller & Ozga, P.O. Box 70098, Rochester Hills, MI, 48307, US

(73) Assignee: Scate Technologies, Inc., Orion, MI (US)

(21) Appl. No.: 11/883,090

(22) PCT Filed: Jan. 26, 2006
(86) PCT No.: PCT/US06/02688

§ 371 Date: Jul. 26, 2007

Related U.S. Application Data
(60) Provisional application No. 60/647,086, filed on Jan. 26, 2005.

(51) Int. Cl. H04N 7/12; G06K 9/36

(52) U.S. Cl. 382/232

(57) ABSTRACT

Video/image analysis and compression systems are described, that can be used in conjunction with image, video, and/or sound files. A master image can be created from a series of images. The difference between the next image and the master image is compared (320 of FIG. 4) and is placed in a key frame located within a video file. Areas of the next image that differ from the master image are cropped (324 of FIG. 4) and the XY anchor positions of the cropped area in relation to the master image are recorded. These areas are then placed in the next sequential key frame. The master image would underlie the sequential cropped areas. Optionally, transparent alpha channels can be applied to the areas that are different from the master image within the cropped areas. The new image is then stored. This procedure would be repeated until no further images from the image series are present.

### CROSS-REFERENCE TO RELATED APPLICATION

The instant application claims priority to U.S. Provisional Patent Application Ser. No. 60/647,086, filed Jan. 26, 2005, the entire specification of which is expressly incorporated herein by reference.

### FIELD OF THE INVENTION

This invention relates generally to image processing systems, and more particularly to video/image analysis and compression systems.

### BACKGROUND OF THE INVENTION

The use of video/image processing systems for allowing a user to view and manipulate video and images is well known in the art. For example, these types of systems have been used in the automotive industry to design and modify automotive interior systems by constructing virtual models thereof. In this manner, various alternative computer models can be easily and inexpensively constructed and modified without requiring the construction of several expensive physical models.

Unfortunately, conventional image processing systems typically require the use of extremely large image files that are very difficult to quickly and efficiently present, especially over the Internet and/or World Wide Web. Current video/image compression methods typically consist of resolution reduction, quality reduction, and/or decreased frames per second rate. Additionally, conventional image processing systems typically do not provide adequate quantitative and/or qualitative information about the presented video/images to allow a user to analyze the video/images for any number of purposes.

Accordingly, there exists a need for new and improved video/image analysis and compression systems.

### SUMMARY OF THE INVENTION

In accordance with the general teachings of the present invention, video/image analysis and compression systems are provided. The present invention can be used with any subject matter, including those that are technically-oriented, and is especially suitable for use with various software applications. The present invention can be Internet-based, for example through the World Wide Web, so that users can access these systems remotely from various locations (e.g., work, home, while traveling, and the like) and at convenient times according to their schedules (e.g., weeknights, weekends, holidays, and the like).

The present invention preferably provides the user with a computerized software environment/interface that allows the user to quickly and easily view, analyze and/or manipulate video/image files of any type of subject matter. The video/image analysis and compression systems of the present invention can be viewed via the Internet or locally on a user's computer or workstation, and is compatible with any operating system, such as but not limited to UNIX, Linux, Windows, Mac, or the like.

In accordance with a first embodiment of the present invention, a new and improved data analysis and compression system is provided, comprising: (1) providing a source of data, wherein the data is selected from the group consisting of sequential images, video, audio, and combinations thereof; (2) designating a master image from the sequential images; (3) comparing one of the sequential images to the master image; (4) creating a new image containing any image differences between the master image and one of the sequential images; and (5) compiling the master image and the new image in a sequence.

In accordance with a second embodiment of the present invention, a new and improved data analysis and compression system is provided, comprising: (1) providing a source of data, wherein the data is selected from the group consisting of sequential images, video, audio, and combinations thereof; (2) designating a master image from the sequential images; (3) determining whether a first sequential image other than the master image exists; (4) if the first sequential image other than the master image exists, comparing the first sequential image to the master image; (5) creating a new image containing any image differences between the master image and the first sequential image; (6) determining whether a second sequential image, other than the master image and the first sequential image, exists; and (7) if the second sequential image, other than the master image and the first sequential image, does not exist, compiling the master image and the new image in a sequence.

In accordance with a third embodiment of the present invention, a new and improved data analysis and compression system is provided, a data analysis and compression system, comprising: (1) providing a source of data, wherein the data is selected from the group consisting of sequential images, video, audio, and combinations thereof; (2) designating a master image from the sequential images; (3) determining whether a first sequential image other than the master image exists; (4) if the first sequential image other than the master image exists, comparing the first sequential image to the master image; (5) creating a first new image containing any image differences between the master image and the first sequential image; (6) determining whether a second sequential image, other than the master image and the first sequential image, exists; (7) if the second sequential image, other than the master image and the first sequential image, exists, comparing the second sequential image to the master image; (8) creating a second new image containing any image differences between the master image and the second sequential image; (9) determining whether a third sequential image, other than the master image, the first sequential image, and the second sequential image, exists; and (10) compiling the master image, the first new image, and the second new image in a sequence.

Additional advantages and features of the present invention will become apparent from the following description and appended claims, taken in conjunction with the accompanying drawings.

### BRIEF DESCRIPTION OF THE DRAWINGS

The present invention will become more fully understood from the detailed description and the accompanying drawings, wherein:

FIG. 1 is a schematic illustration of a flowchart illustrating the primary processing steps of a login sub-system for video/image analysis and compression systems of the present invention, in accordance with a first embodiment of the present invention;

FIG. 2 is a schematic illustration of a flowchart illustrating the primary processing steps of a video/image analysis system of the present invention, in accordance with a second embodiment of the present invention;

FIG. 3 is a schematic illustration of a flowchart illustrating the primary processing steps of a sound analysis sub-system for video/image analysis and compression systems of the present invention, in accordance with a third embodiment of the present invention;

FIG. 4 is a schematic illustration of a flowchart illustrating the primary processing steps of a video/image compression system of the present invention, in accordance with a fourth embodiment of the present invention;

FIG. 5 is a schematic illustration of a flowchart illustrating the primary processing steps of a query sub-system for video/image analysis and compression systems of the present invention, in accordance with a fifth embodiment of the present invention;

FIG. 6 is a view of a screen capture illustrating a main interface screen of a video/image compression system of the present invention, in accordance with a sixth embodiment of the present invention;

FIG. 7 is a view of a screen capture illustrating a video/image entry interface screen of a video/image compression system of the present invention, in accordance with a seventh embodiment of the present invention;

FIG. 8 is a view of a screen capture illustrating a master image screen of a video/image compression system of the present invention, in accordance with an eighth embodiment of the present invention;

FIG. 9 is a view of a screen capture illustrating a second image to be compared with the master image screen of a video/image compression system of the present invention, in accordance with a ninth embodiment of the present invention;

FIG. 10 is a view of a screen capture illustrating the difference between the master image and the second image screen of a video/image compression system of the present invention, in accordance with a tenth embodiment of the present invention;

FIG. 11 is a view of a screen capture illustrating a main interface screen of a video/image analysis system of the present invention, in accordance with an eleventh embodiment of the present invention;

FIG. 12 is a view of a screen capture illustrating a login screen of a video/image analysis system of the present invention, in accordance with a twelfth embodiment of the present invention;

FIG. 13 is a view of a screen capture illustrating an administrative control panel screen of a video/image analysis system of the present invention, in accordance with a thirteenth embodiment of the present invention;

FIG. 14 is a view of a screen capture illustrating an add user panel screen of a video/image analysis system of the present invention, in accordance with a fourteenth embodiment of the present invention;

FIG. 15 is a view of a screen capture illustrating an add study panel screen of a video/image analysis system of the present invention, in accordance with a fifteenth embodiment of the present invention;

FIG. 16 is a view of a screen capture illustrating an add image panel screen of a video/image analysis system of the present invention, in accordance with a sixteenth embodiment of the present invention;

FIG. 17 is a view of a screen capture illustrating a query panel screen of a video/image analysis system of the present invention, in accordance with a seventeenth embodiment of the present invention;

FIG. 18 is a view of a screen capture illustrating a first analysis result panel screen of a video/image analysis system of the present invention, in accordance with an eighteenth embodiment of the present invention;

FIG. 19 is a view of a screen capture illustrating a second analysis result panel screen of a video/image analysis system of the present invention, in accordance with a nineteenth embodiment of the present invention; and

FIG. 20 is a view of a screen capture illustrating several applications of the video/image analysis and compression systems of the present invention, in accordance with a twentieth embodiment of the present invention.

### DETAILED DESCRIPTION OF THE EMBODIMENTS

The following description of the preferred embodiment(s) is merely exemplary in nature and is in no way intended to limit the invention, its applications, or uses.

In order to fully appreciate the benefits and features of the systems of the present invention, it is assumed that an individual practicing the present invention will preferably have: access to a computer (and is conversant with the basic functions thereof; an Internet service provider (“ISP”) (e.g., AOL, JUNO, or the like) with e-mail capability; a Web browser (e.g., INTERNET EXPLORER, NETSCAPE, or the like); any required plug-ins (e.g., FLASH, SHOCKWAVE, JAVA VIRTUAL MACHINE, or the like); and have the ability to navigate successfully to any given uniform resource locator (“URL”).

Preferably, the first step is for the individual to successfully navigate to the URL of the main Web Site that contains the systems of the present invention (e.g., with the aid of a Web browser, such as INTERNET EXPLORER, NETSCAPE, or the like). By way of a non-limiting example, the URL http://www.scate.com has been designated as the main Web Site for the systems of the present invention. Once this URL is accessed clear instructions are available on navigating to the exact invention page. Once accessed, it will cause a graphical movie screen (e.g., FLASH, SHOCKWAVE, JAVA, HTML or the like) to be displayed as a result of a action 30 within the HyperText Markup Language (“HTML”) Web interface file (e.g., written with the aid of a programming language, such as but not limited to JavaScript), thus letting the individual know that he has arrived at the correct system Web Site. It should be appreciated that the user will occasionally be required to click on various links in order to navigate to various portions of the Web Site.

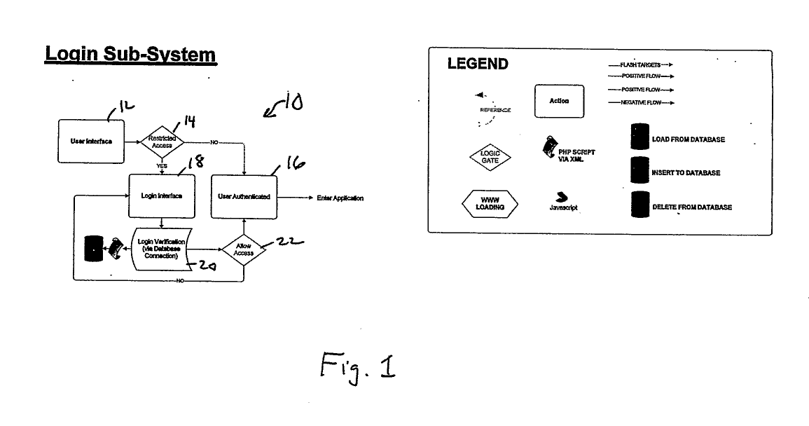

Referring to FIG. 1, there is generally shown a schematic view of a flowchart illustrating the primary processing steps of a login sub-system 10 for video/image analysis and compression systems of the present invention, in accordance with a first embodiment of the present invention. An intended function of the login sub-system 10 is to permit only authorized users to access the systems of the present invention. As previously noted, the systems of the present invention can be practiced in conjunction with the Internet, World Wide Web, intranets, extranets, electronic media (e.g., CD/DVD-based systems), or the like. Alternatively, the systems of the present invention can be directly loaded onto stand-alone computer workstations, e.g., for training purposes. Although the systems of the present invention will refer generally to software program(s) that have primary application to automotive engineering, it should be appreciated that this is for illustrative purposes only, and that the present invention can be practiced with any type of subject matter.

Initially, a graphical movie screen 12 is preferably displayed, e.g., a user interface, which informs the user that they have reached the systems home page.

At this point, a logic gate 14 is preferably reached wherein a decision is made whether access to the systems by the user is restricted or not.

If access is not restricted, a graphical movie 16 is preferably displayed that will alert the user that access was granted, i.e., the user was authenticated, and will then be allowed to enter the particular systems of choice, as will be explained herein.

If access is restricted, a graphical movie 18 is preferably displayed that will alert the user that information is required to access the systems, i.e., the user will encounter a login interface screen.

The next step 20 is for the requested login information to preferably be entered for login verification purposes, e.g., through a server access database script such as but not limited to PHP script (e.g., a hypertext preprocessor) or ASP (e.g., active server pages) via a data packaging code such as but not limited to XML (e.g., Extensible Markup Language).

At this point, a logic gate 22 is preferably reached wherein a decision is made whether access to the systems by the user is to be allowed or not.

If access is not allowed, the user is preferably redirected to the graphical movie 18, i.e., the user will again encounter the login interface screen, and will once again need to provide the requested login information.

If access is allowed, the user is preferably directed to the graphical movie 16, i.e., the user was authenticated, and will then be allowed to enter the particular systems of choice, as will be explained herein.

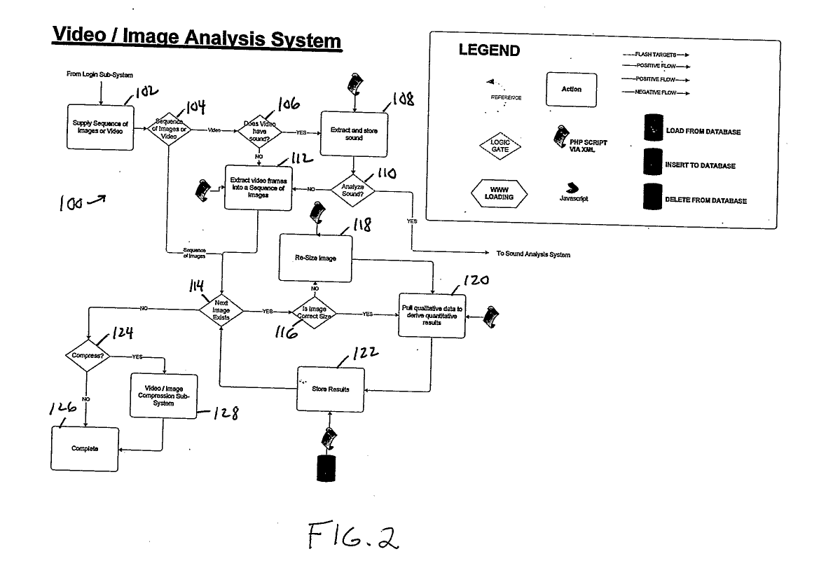

Referring to FIG. 2, there is shown a schematic illustration of a flowchart illustrating the primary processing steps of a video/image analysis system 100 of the present invention, in accordance with a second embodiment of the present invention.

Assuming that the user has successfully logged in, initially, a graphical movie screen 102 is preferably displayed, e.g., a supply sequence of images or video, which informs the user which set of images or videos are available for analysis.

At this point, a logic gate 104 is preferably reached wherein a decision is made whether the sequence consists of images or video.

If the sequence consists of video, a logic gate 106 is preferably reached wherein a decision is made whether the video includes sound or not.

If the video includes sound, the next step 108 is to preferably extract and store the sound, e.g., through a server access database script such as but not limited to PHP script (e.g., a hypertext preprocessor) or ASP (e.g., active server pages) via a data packaging code such as but not limited to XML (e.g., Extensible Markup Language).

At this point, a logic gate 110 is preferably reached wherein a decision is made whether to analyze the sound or not.

If the decision is to analyze the sound, a sound analysis system is preferably accessed, to be described herein.

If the decision is not to analyze the sound, the next step 112 is to preferably extract video frames into a sequence of images, e.g., through a server access database script such as but not limited to PHP script (e.g., a hypertext preprocessor) or ASP (e.g., active server pages) via a data packaging code such as but not limited to XML (e.g., Extensible Markup Language).

If the decision at the logic gate 106 is that the video does not have sound, then step 112 is preferably reached wherein the video frames are extracted into a sequence of images, e.g., through a server access database script such as but not limited to PHP script (e.g., a hypertext preprocessor) or ASP (e.g., active server pages) via a data packaging code such as but not limited to XML (e.g., Extensible Markup Language).

If the decision at logic gate 104 is that the sequence consists of images (or if the video frames had been extracted into a sequence of images in step 112), a logic gate 114 is preferably reached wherein a decision is made whether a next image exists or not.

If the decision is made that there are other images, then a logic gate 116 is preferably reached wherein a decision is made whether the image is the correct size.

If the decision is made that the image is not the correct size, then step 118 is preferably reached wherein the image is resized, e.g., through a server access database script such as but not limited to PHP script (e.g., a hypertext preprocessor) or ASP (e.g., active server pages) via a data packaging code such as but not limited to XML (e.g., Extensible Markup Language).

If the image is resized, then step 120 is preferably reached wherein qualitative data such as the color information of each pixel is pulled from the images so as to derive quantitative results that show the area of the number of pixels of the image occupied by each color therefrom, e.g., through a server access database script such as but not limited to PHP script (e.g., a hypertext preprocessor) or ASP (e.g., active server pages) via a data packaging code such as but not limited to XML (e.g., Extensible Markup Language).

If the decision is made that the image is the correct size, then step 120 is preferably reached wherein qualitative data such as the color information of each pixel is pulled from the images so as to derive quantitative results that show the area or the number of pixels of the image occupied by each color therefrom, e.g., through a server access database script such as but not limited to PHP script (e.g., a hypertext preprocessor) or ASP (e.g., active server pages) via a data packaging code such as but not limited to XML (e.g., Extensible Markup Language).

The next step 122 is to store the results, i.e., quantitative data that show the area or the number of pixels of the image occupied by each color, which is preferably client-directed to a database, such as but not limited to MySQL or SQL Database (e.g., an open source relational database management system) through a server access database script such as but not limited to PHP script (e.g., a hypertext preprocessor) or ASP (e.g., active server pages) via a data packaging code such as but not limited to XML (e.g., Extensible Markup Language).

If the decision is made that there are no further images, then a logic gate 124 is preferably reached wherein a decision is made whether to compress the images or not.

If the decision is made not to compress the images, a graphical movie screen 126 is preferably displayed, which informs the user that the process is complete.

If the decision is made to compress the images, a graphical movie screen 128 is preferably displayed, which informs the user that a video-image compression sub-system is accessed, to be described herein. Once, the compression process has been completed, the graphical movie screen 126 is preferably displayed, which informs the user that the compression process is complete.

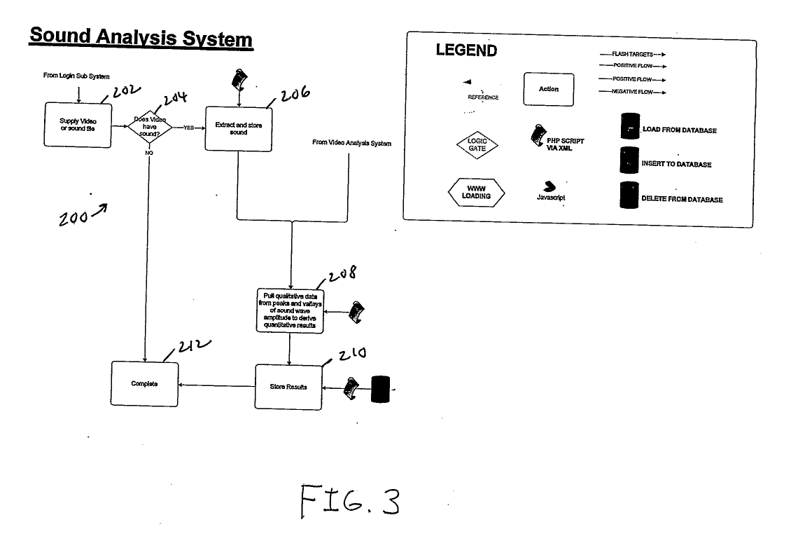

Referring to FIG. 3, there is shown a schematic illustration of a flowchart illustrating the primary processing steps of a sound analysis sub-system 200 for video/image analysis and compression systems of the present invention, in accordance with a third embodiment of the present invention.

Assuming that the user has successfully logged in, initially, a graphical movie screen 202 is preferably displayed, e.g., to supply a video or sound file, which informs the user which video or sound files are available for analysis.

At this point, a logic gate 204 is preferably reached wherein a decision is made whether the video contains sound or not.

If the decision is made that the video contains sound, then step 206 is preferably reached wherein the sound is extracted and stored, e.g., through a server access database script such as but not limited to PHP script (e.g., a hypertext preprocessor) or ASP (e.g., active server pages) via a data packaging code such as but not limited to XML (e.g., Extensible Markup Language).

The next step 208 is to pull qualitative data from the peaks and valleys of the sound wave amplitudes to derive quantitative results therefrom, e.g., through a server access database script such as but not limited to PHP script (e.g., a hypertext preprocessor) or ASP (e.g., active server pages) via a data packaging code such as but not limited to XML (e.g., Extensible Markup Language). The data can also be pulled from system 100.

The next step 210 is to store the results, i.e., qualitative data, which is preferably client-directed to a database, such as but not limited to MySQL or SQL Database (e.g., an open source relational database management system) through a server access database script such as but not limited to PHP script (e.g., a hypertext preprocessor) or ASP (e.g., active server pages) via a data packaging code such as but not limited to XML (e.g., Extensible Markup Language).

Next, a graphical movie screen 212 is preferably displayed which informs the user that the sound analysis process is complete.

If the decision is made that the video does not contain sound, then graphical movie screen 212 is preferably displayed which informs the user that the sound analysis process is complete.

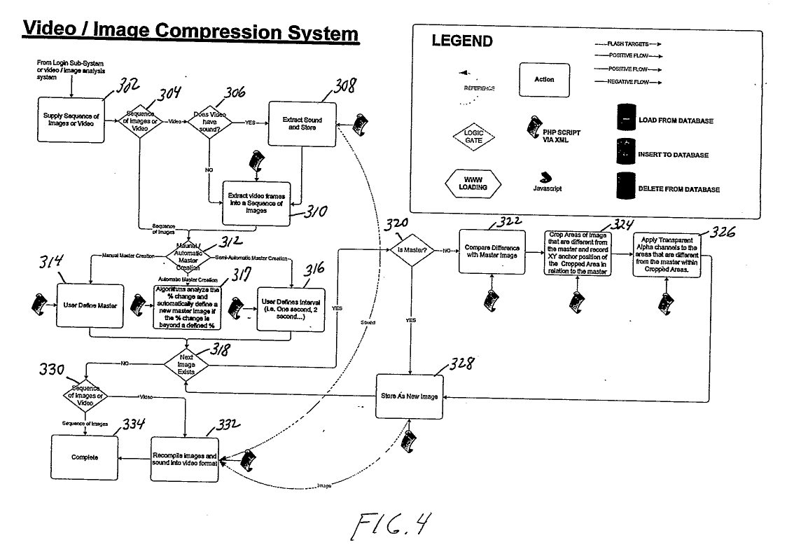

Referring to FIG. 4, there is shown a schematic illustration of a flowchart illustrating the primary processing steps of a video/image compression system 300 of the present invention, in accordance with a fourth embodiment of the present invention.

Assuming that the user has successfully logged in or accessed system 100, initially, a graphical movie screen 302 is preferably displayed, e.g., to supply a sequence of images or video, which informs the user which images or videos are available for compression.

At this point, a logic gate 304 is preferably reached wherein a decision is made whether a sequence of images or video are present.

If the decision is made that video is present, then a logic gate 306 is preferably reached wherein a decision is made whether the video contains sound or not.

The next step 308 is to extract and store the sound, e.g., through a server access database script such as but not limited to PHP script (e.g., a hypertext preprocessor) or ASP (e.g., active server pages) and catalogue it via a data packaging code such as but not limited to XML (e.g., Extensible Markup Language). The data can also be pulled from system 100.

The next step 310 is to extract video frames into a sequence of images, e.g., through a server access database script such as but not limited to PHP script (e.g., a hypertext preprocessor) or ASP (e.g., active server pages) and catalogue them via a data packaging code such as but not limited to XML (e.g., Extensible Markup Language).

If the decision is made that the video does not contain sound, then the user is directed to step 310.

If the decision is made that a sequence of images is present (or if the video frames have been extracted into a sequence of images in step 310), then a logic gate 312 is preferably reached wherein a decision is made whether a manual or automatic master image creation process will take place.

There are three alternative steps that are available. One step 314 is for the user to define the master image, e.g., through a server access database script such as but not limited to PHP script (e.g., a hypertext preprocessor) or ASP (e.g., active server pages) and catalogue them via a data packaging code such as but not limited to XML (e.g., Extensible Markup Language). Another step 316 is for the user to define the interval (e.g., one second, two seconds, and so forth), e.g., through a server access database script such as but not limited to PHP script (e.g., a hypertext preprocessor) or ASP (e.g., active server pages) and catalogue them via a data packaging code such as but not limited to XML (e.g., Extensible Markup Language). Still another step 317 is to assume the first image in the series as a master image and there after automatically detect other master images by calculating the percentage change in the pixel data (color) from the current master image and next image in the series. If the percentage change exceeds the user defined value, the next image becomes a master image, e.g., through a server access database script such as but not limited to PHP script (e.g., a hypertext preprocessor) or ASP (e.g., active server pages) and catalogue them via a data packaging code such as but not limited to XML (e.g., Extensible Markup Language).

Regardless of which step is chosen, at this point, a logic gate 318 is preferably reached wherein a decision is made whether a next image exists or not.

If the decision is made that a next image exists, then a logic gate 320 is preferably reached wherein a decision is made whether the next image is the master image or not.

If the decision is made that the next image is not the master image, then the next step 322 is to compare the difference between the next image and the master image and is placed in a key frame located within a video, file, such as but not limited to FLASH, WMV, AVI and/or the like, e.g., through a server access database script such as but not limited to PHP script (e.g., a hypertext preprocessor) or ASP (e.g., active server pages) and catalogue them via a data packaging code such as but not limited to XML (e.g., Extensible Markup Language).

The next step 324 is to crop areas of the next image that are different from the master image and record the XY anchor position of the cropped area in relation to the master image, e.g., through a server access database script such as but not limited to PHP script (e.g., a hypertext preprocessor) or ASP (e.g., active server pages) and catalogue it via a data packaging code such as but not limited to XML (e.g., Extensible Markup Language). These areas are then placed in the next sequential key frame. The master image would underlie the sequential cropped areas.

The next step 326 is to optionally apply transparent alpha channels to the areas that are different from the master image within the cropped areas, e.g., through a server access database script such as but not limited to PHP script (e.g., a hypertext preprocessor) or ASP (e.g., active server pages) and catalogue it via a data packaging code such as but not limited to XML (e.g., Extensible Markup Language).

The next step 328 is to store the new image file, e.g., through a server access database script such as but not limited to PHP script (e.g., a hypertext preprocessor) or ASP (e.g., active server pages) and catalogue it via a data packaging code such as but not limited to XML (e.g., Extensible Markup Language).

If the decision is made that the next image is the master image, then the user would preferably be directed to step 328.

At this point, the user would preferably be directed back to logic gate 318, i.e., wherein a decision is made whether a next image exists or not.

If the decision is made that a next image does not exist, then a logic gate 330 is preferably reached wherein a decision is made whether there is a sequence of images or video present or not.

If the decision is made that a video is present, then the next step 332 is recompile images and sound, if present, into a video format (e.g., FLASH, WMV, AVI and/or the like), e.g., through a server access database script such as but not limited to PHP script (e.g., a hypertext preprocessor) or ASP (e.g., active server pages) and catalogue it via a data packaging code such as but not limited to XML (e.g., Extensible Markup Language). The sound and image information can also be provided from steps 308 and 328, respectively.

A graphical movie screen 334 is preferably displayed which informs the user that the video-image compression process is complete.

If the decision is made that a sequence of images is present, then the user is preferably directed to the graphical movie screen 334.

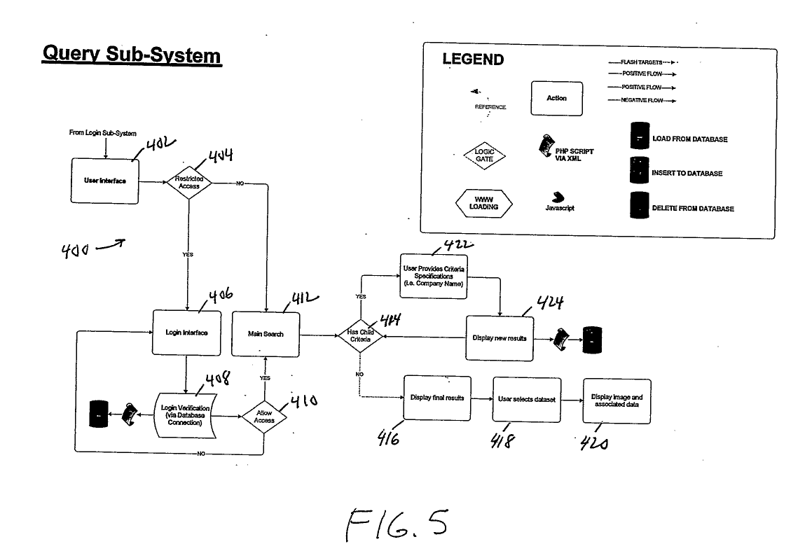

Referring to FIG. 5, there is shown a schematic illustration of a flowchart illustrating the primary processing steps of a query sub-system 400 for video/image analysis and compression systems of the present invention, in accordance with a fifth embodiment of the present invention.

Assuming that the user has successfully logged in, initially, a graphical movie screen 402 is preferably displayed which informs the user that they have reached the user interface screen.

At this point, a logic gate 404 is preferably reached wherein a decision is made whether access to the systems is restricted or not.

If the decision is made that access is restricted, then the user is preferably directed to the graphical movie screen 406 which informs the user that they have reached the login interface screen.

The next step 408 is to perform a login verification, e.g., which is preferably client-directed from a database, such as but not limited to MySQL or SQL Database (e.g., an open source relational database management system) through a server access database script such as but not limited to PHP script (e.g., a hypertext preprocessor) or ASP (e.g., active server pages) via a data packaging code such as but not limited to XML (e.g., Extensible Markup Language).

At this point, a logic gate 410 is preferably reached wherein a decision is made whether or not to allow access to the user.

If the decision is made that access is not allowed, then the user is preferably redirected to the graphical movie screen 406 which informs the user that they have reached the login interface screen.

If the decision is made that access is allowed, then the user is preferably directed to a graphical movie screen 412 which informs the user that they have reached the main search screen.

If the decision is made that access is not restricted, then the user is preferably directed to the graphical movie screen 412 which informs the user that they have reached the main search screen.

Once the user has reached the main search screen, at this point a logic gate 414 is preferably reached wherein a decision is made whether criteria is to be input or not.

If the decision is made that criteria is not to be inputted, then the user is preferably directed to the graphical movie screen 416 which displays the final search results.

The next step 418 is to allow the user to select a dataset.

The next step 420 is to display image(s) and associated data.

If the decision is made that criteria can be inputted, then the user is preferably directed to the graphical movie screen 422 which allows the user to provide criteria specifications.

The next step 424 is to display the new search results, e.g., which is preferably client-directed from a database, such as but not limited to MySQL or SQL Database (e.g., an open source relational database management system) through a server access database script such as but not limited to PHP script (e.g., a hypertext preprocessor) or ASP (e.g., active server pages) via a data packaging code such as but not limited to XML (e.g., Extensible Markup Language).

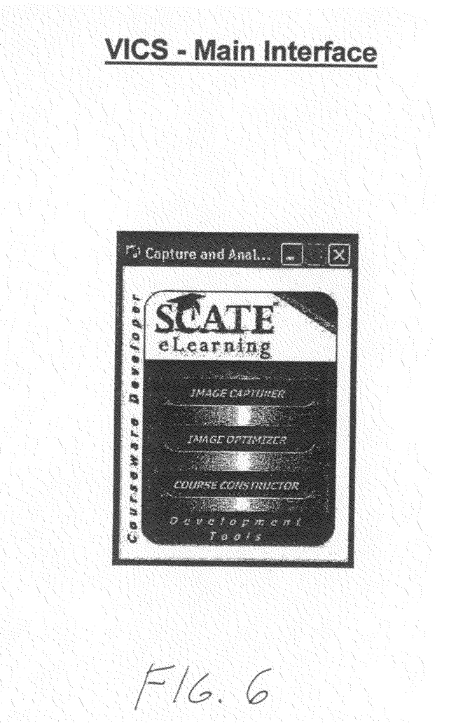

In order to demonstrate the various features of the present invention, as well as the user-friendliness of the present invention, several screen captures are presented in FIGS. 6-20, the descriptions of which are presented below.

FIGS. 6-10 generally relate to the video/image compression system of the present invention.

Referring to FIG. 6, there is shown a view of a screen capture illustrating a main interface screen of a video/image compression system of the present invention, in accordance with a sixth embodiment of the present invention. This screen illustrates the usefulness of the present invention in obtaining the differences between the various images provided in a directory or video file, either prior to or after compression.

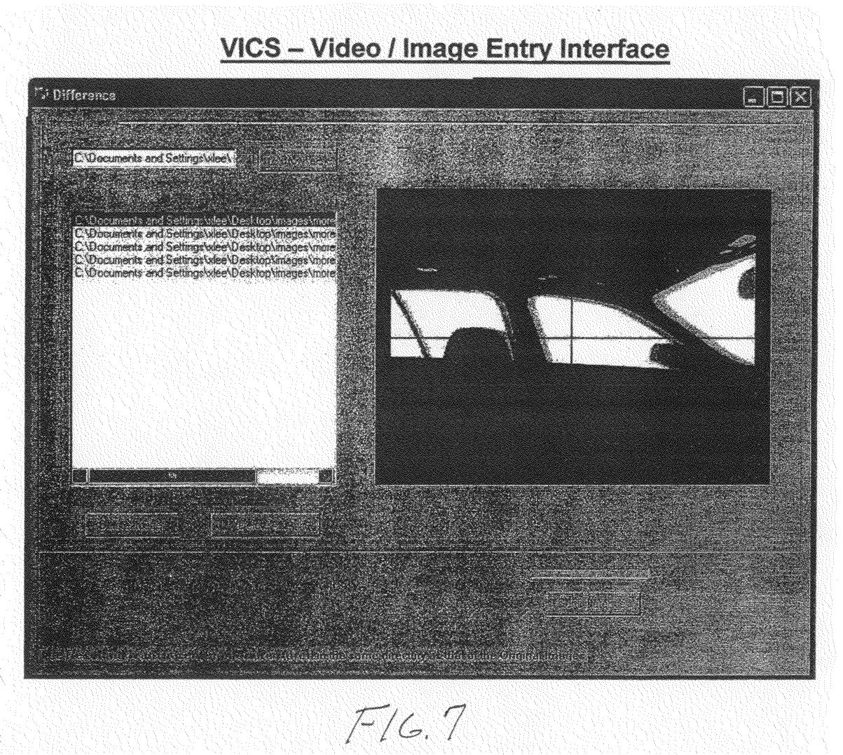

Referring to FIG. 7, there is shown a view of a screen capture illustrating a video/image entry interface screen of a video/image compression system of the present invention, in accordance with a seventh embodiment of the present invention.

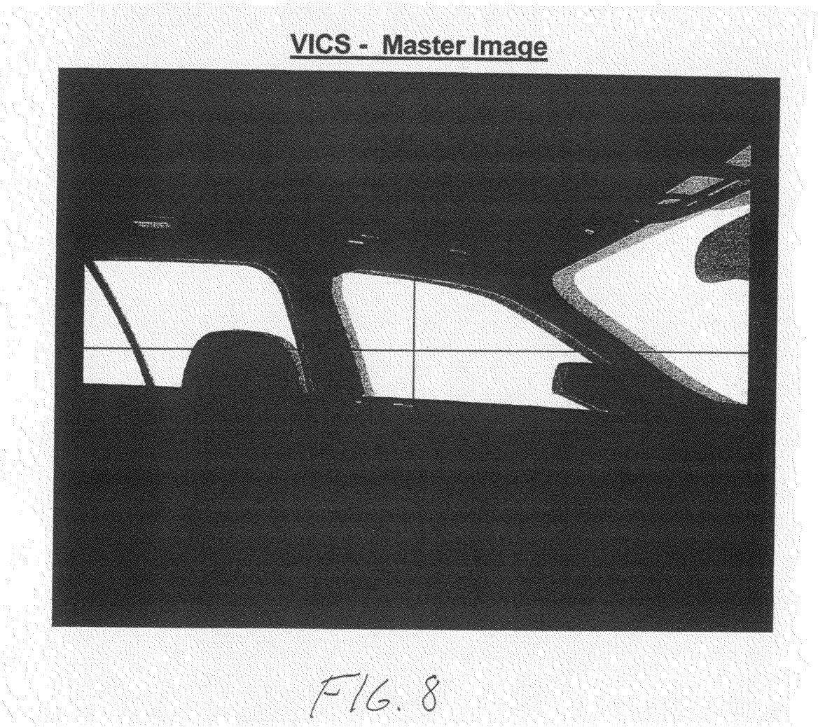

Referring to FIG. 8, there is shown a view of a screen capture illustrating a master image screen of a video/image compression system of the present invention, in accordance with an eighth embodiment of the present invention.

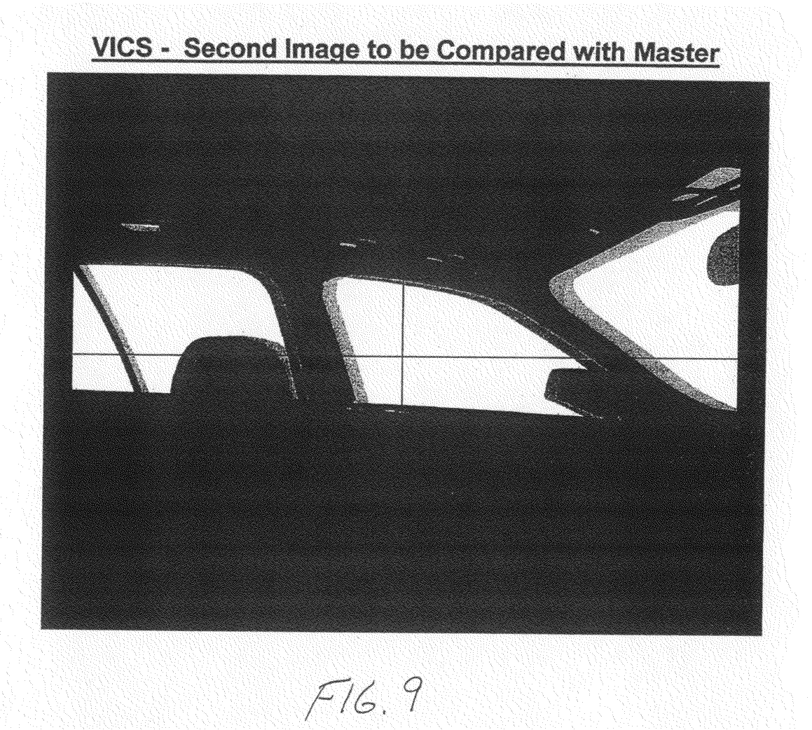

Referring to FIG. 9, there is shown a view of a screen capture illustrating a second image to be compared with the master image screen of a video/image compression system of the present invention, in accordance with a ninth embodiment of the present invention.

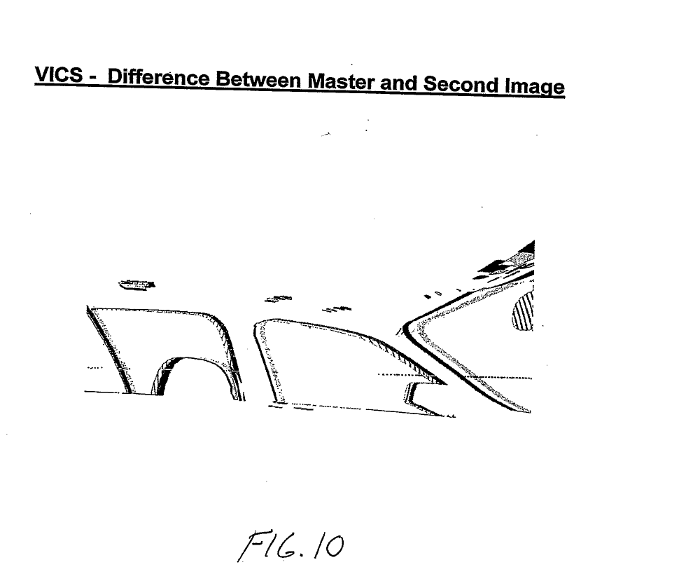

Referring to FIG. 10, there is shown a view of a screen capture illustrating the difference between the master image and the second image screen of a video/image compression system of the present invention, in accordance with a tenth embodiment of the present invention. The data representative of this image would typically be placed in the sequential key frame and overlaid the master image, as previously described.

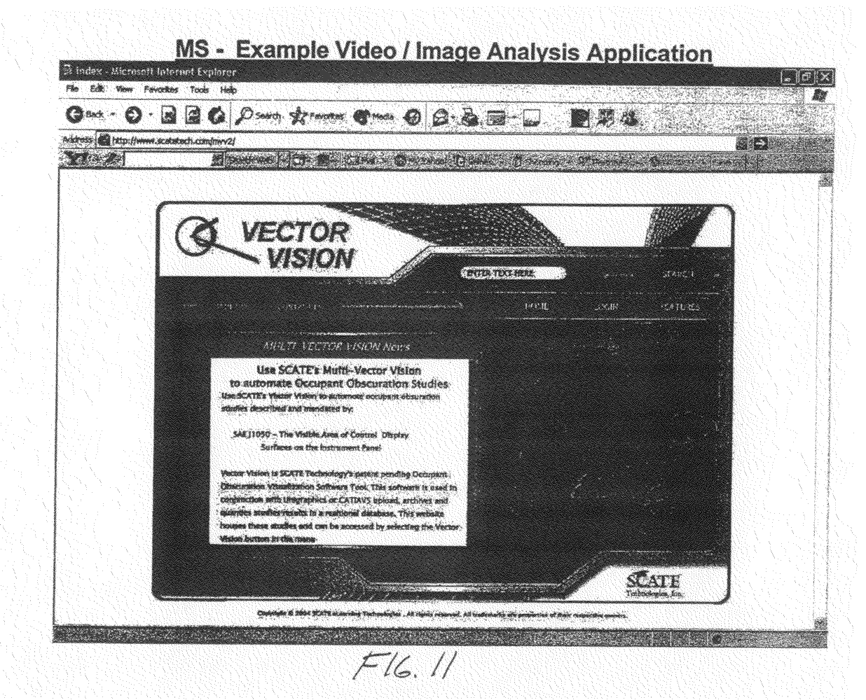

FIGS. 11-19 generally relate to the video/image analysis system of the present invention.

Referring to FIG. 11, there is shown a view of a screen capture illustrating a main interface screen of a video/image analysis system of the present invention, in accordance with an eleventh embodiment of the present invention.

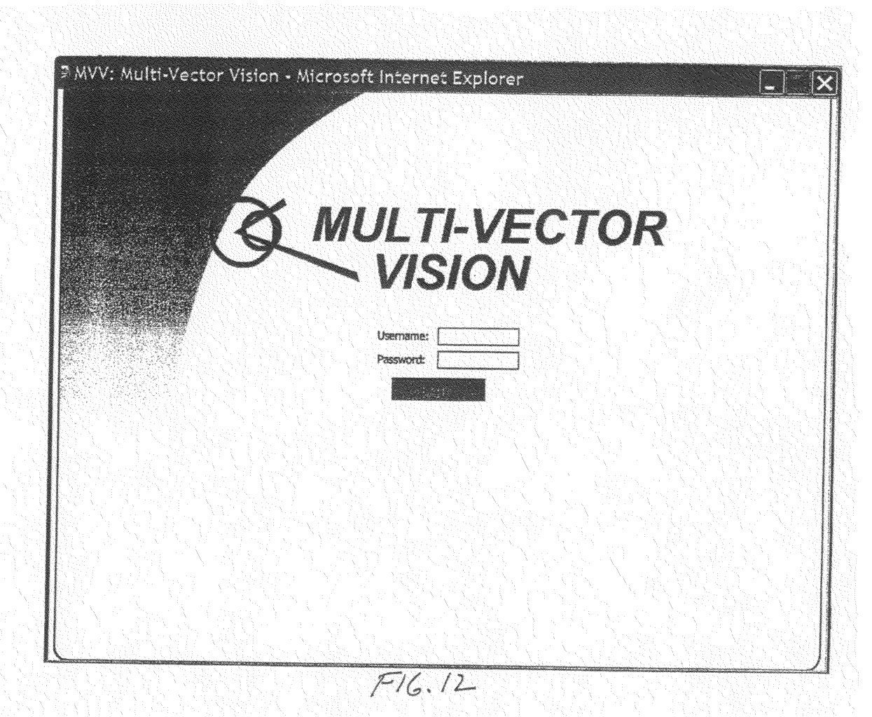

Referring to FIG. 12, there is shown a view of a screen capture illustrating a login screen of a video/image analysis system of the present invention, in accordance with a twelfth embodiment of the present invention.

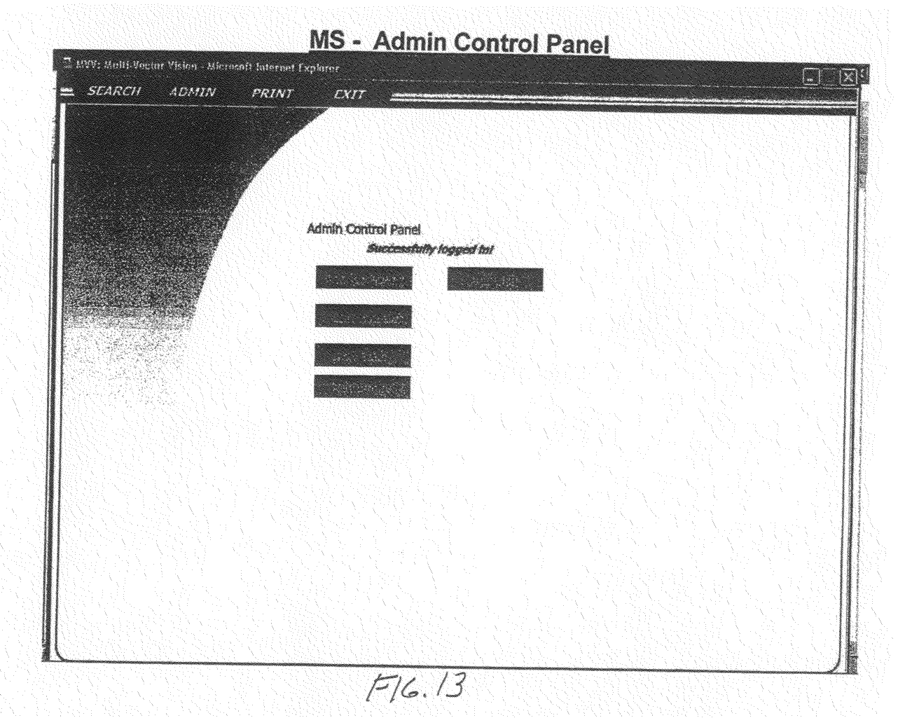

Referring to FIG. 13, there is shown a view of a screen capture illustrating an administrative control panel screen of a video/image analysis system of the present invention, in accordance with a thirteenth embodiment of the present invention.

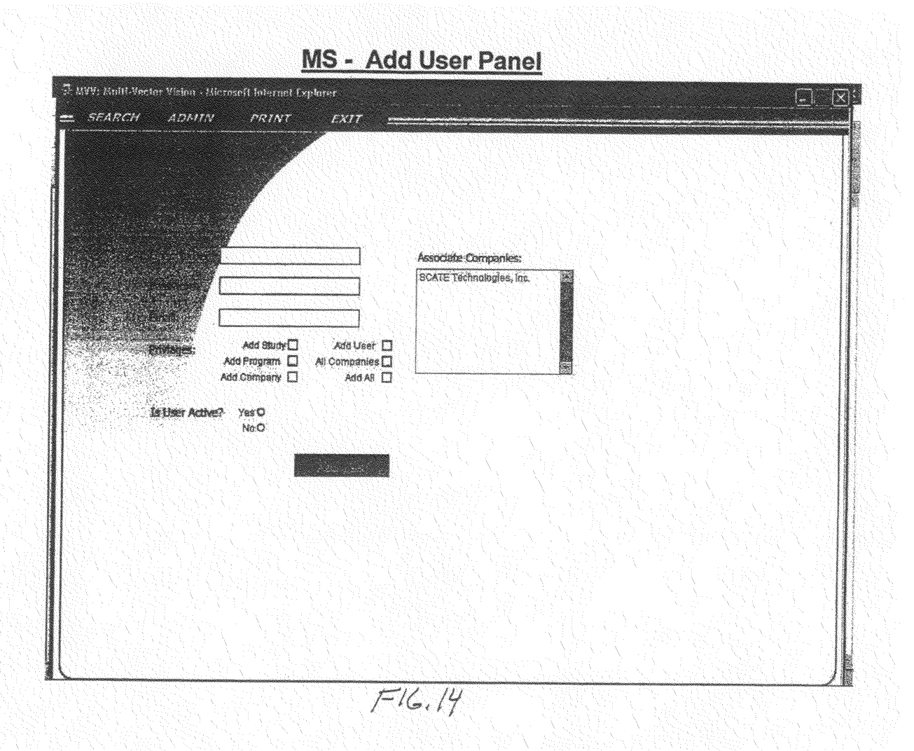

Referring to FIG. 14, there is shown a view of a screen capture illustrating an add user panel screen of a video/image analysis system of the present invention, in accordance with a fourteenth embodiment of the present invention.

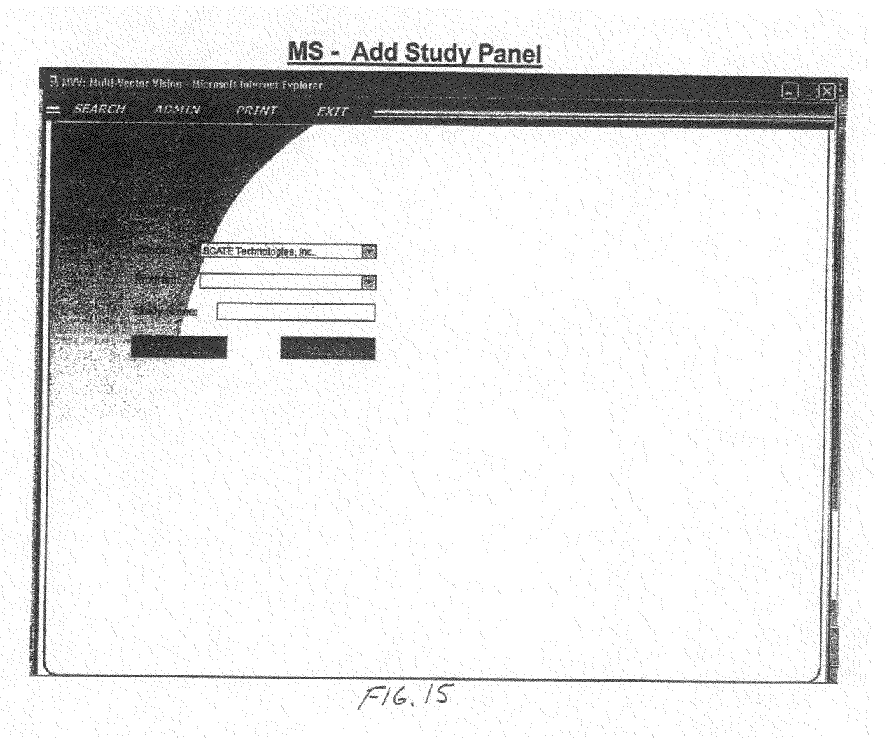

Referring to FIG. 15, there is shown a view of a screen capture illustrating an add study panel screen of a video/image analysis system of the present invention, in accordance with a fifteenth embodiment of the present invention.

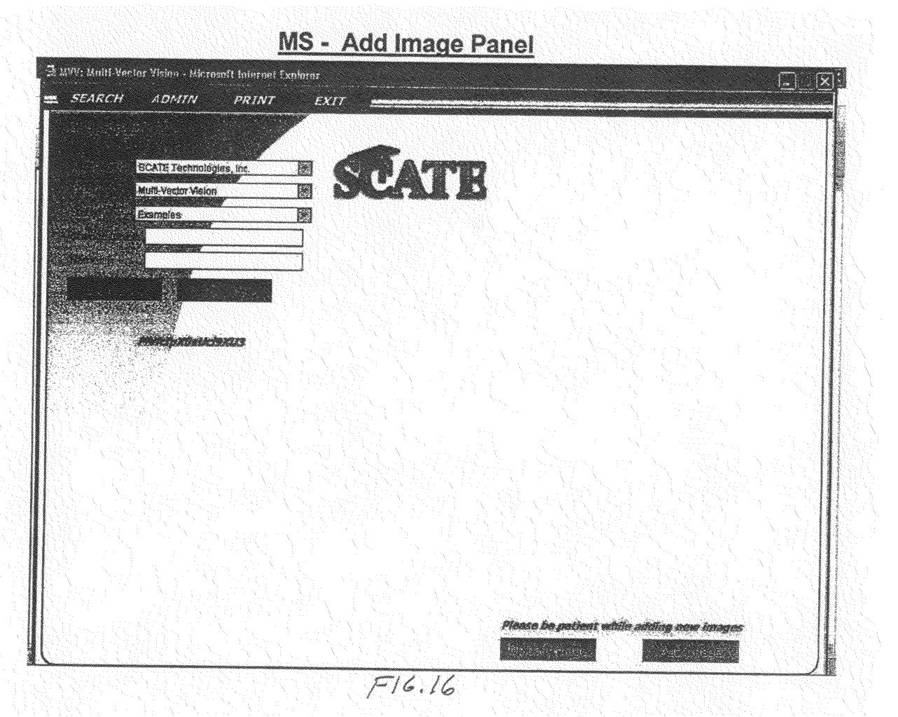

Referring to FIG. 16, there is shown a view of a screen capture illustrating an add image panel screen of a video/image analysis system of the present invention, in accordance with a sixteenth embodiment of the present invention.

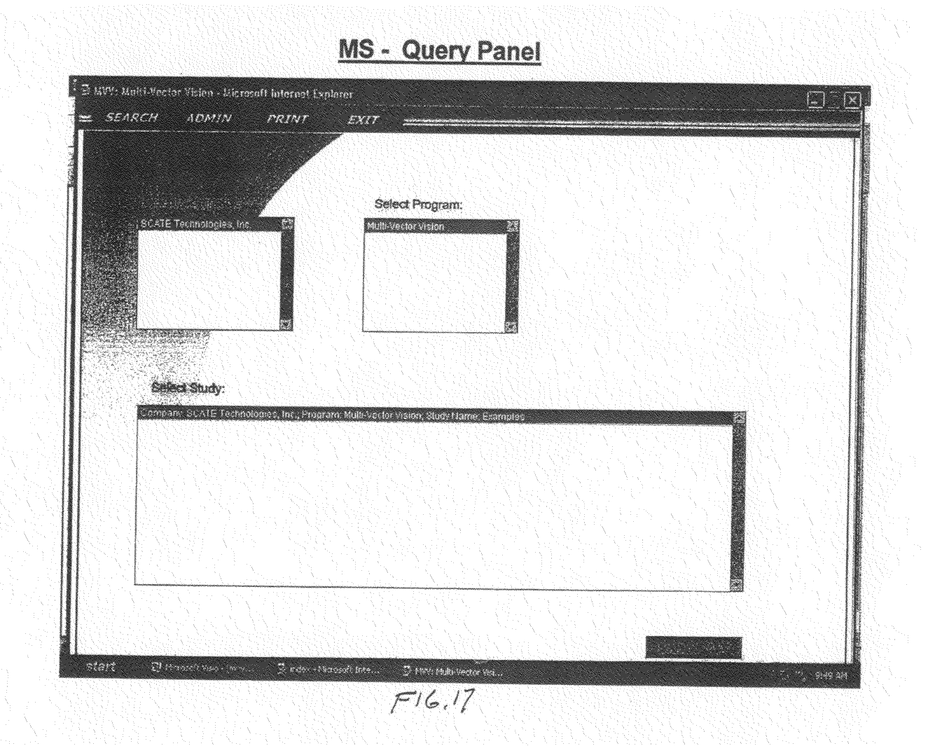

Referring to FIG. 17, there is shown a view of a screen capture illustrating a query panel screen of a video/image analysis system of the present invention, in accordance with a seventeenth embodiment of the present invention.

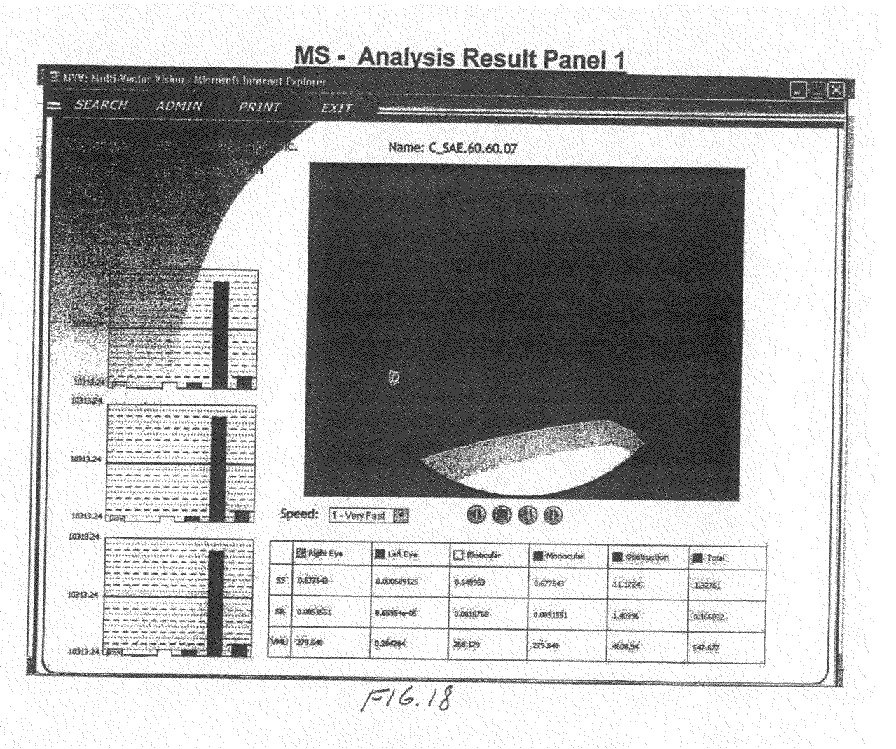

Referring to FIG. 18, there is shown a view of a screen capture illustrating a first analysis result panel screen of a video/image analysis system of the present invention, in accordance with an eighteenth embodiment of the present invention. This screen provides qualitative and/or quantitative data to the user from a data collection system derived directly from the analysis system of the present invention.

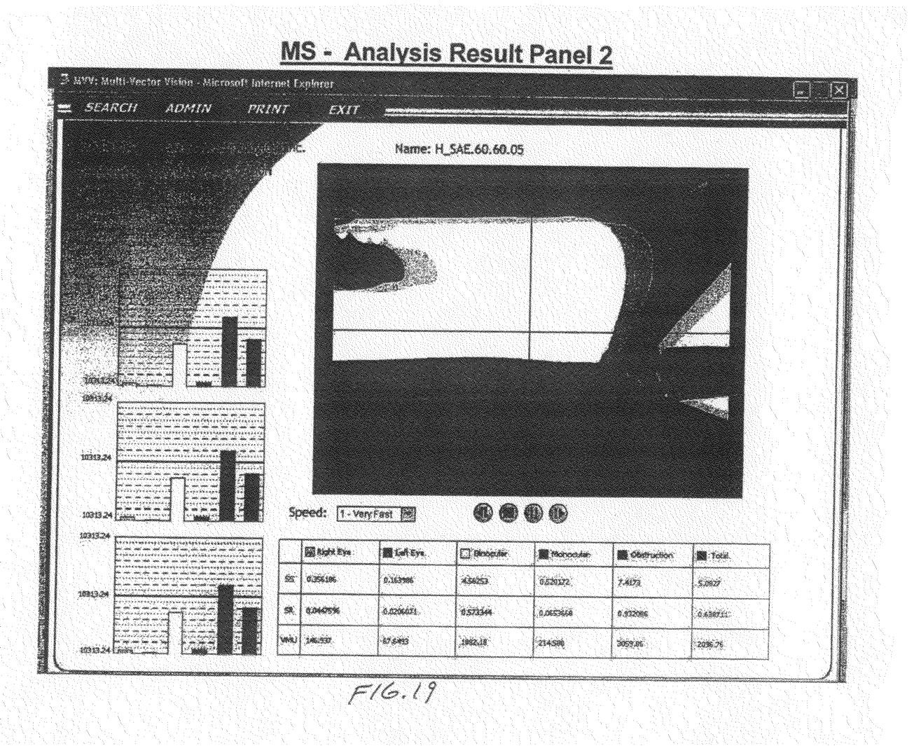

Referring to FIG. 19, there is shown a view of a screen capture illustrating a second analysis result panel screen of a video/image analysis system of the present invention, in accordance with a nineteenth embodiment of the present invention.

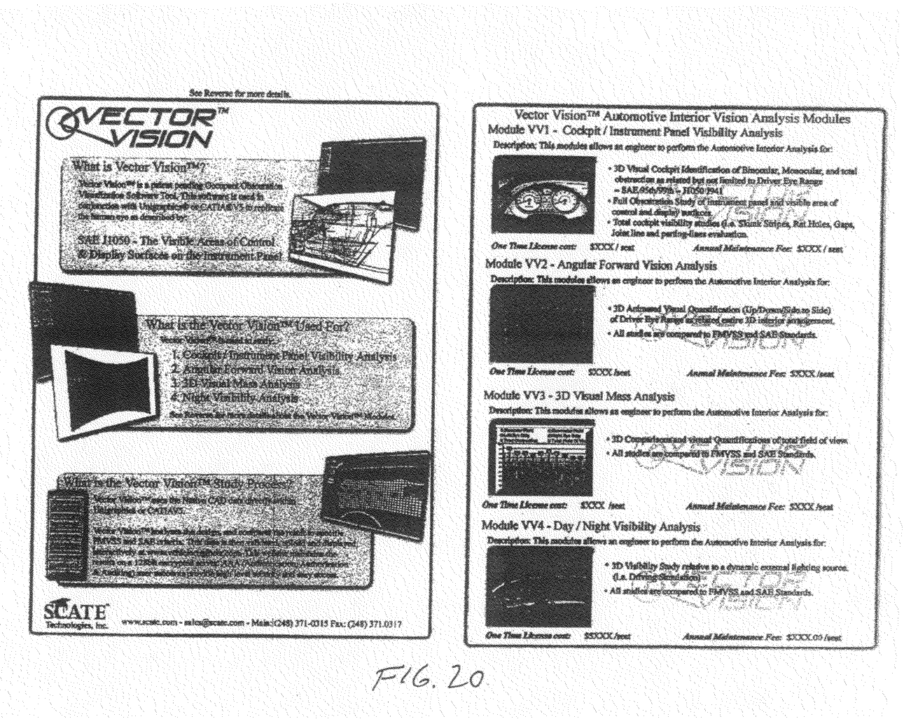

FIG. 20 generally relates to the video/image analysis and compression systems of the present invention.

Referring to FIG. 20, there is shown a view of a screen capture illustrating several applications of the video/image analysis and compression systems of the present invention, in accordance with a twentieth embodiment of the present invention.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A data analysis and compression system, comprising:
providing a source of data, wherein the data is selected from the group consisting of sequential images, video, audio, and combinations thereof;
designating a master image from the sequential images;
comparing one of the sequential images to the master image;
creating a new image containing any image differences between the master image and one of the sequential images; and
compiling the master image and the new image in a sequence.

2. The invention according to claim 1, wherein the video is converted into a series of sequential images.

3. The invention according to claim 2, further comprising;
designating a master image from the series of sequential images;
comparing one of the series of sequential images to the master image;
creating a new image containing any image differences between the master image and one of the series of sequential images; and
compiling the master image and the new image in a sequence.

4. The invention according to claim 3, wherein the audio is combined with the master image and the new image in a video format.

5. The invention according to claim 1, wherein the audio is extracted from the source of data and stored in a data storage medium.

6. The invention according to claim 5, wherein the stored audio is analyzed by an audio analysis system.

7. The invention according to claim 6, wherein the audio analysis system is operable to extract qualitative data from at least one peak and valley of a sound wave amplitude so as to derive a quantitative result.

8. A data analysis and compression system, comprising:
providing a source of data, wherein the data is selected from the group consisting of sequential images, video, audio, and combinations thereof;
designating a master image from the sequential images;
determining whether a first sequential image other than the master image exists;
if the first sequential image other than the master image exists, comparing the first sequential image to the master image;
creating a new image containing any image differences between the master image and the first sequential image;
determining whether a second sequential image, other than the master image and the first sequential image, exists; and
if the second sequential image, other than the master image and the first sequential image, does not exist, compiling the master image and the new image in a sequence.

9. The invention according to claim 8, wherein the video is converted into a series of sequential images.

10. The invention according to claim 9, further comprising;
designating a master image from the series of sequential images;
comparing one of the series of sequential images to the master image;
creating a new image containing any image differences between the master image and one of the series of sequential images; and
compiling the master image and the new image in a sequence.

11. The invention according to claim 10, wherein the audio is combined with the master image and the new image in a video format.

12. The invention according to claim 10, wherein the audio is extracted from the source of data and stored in a data storage medium.

13. The invention according to claim 12, wherein the stored audio is analyzed by an audio analysis system.

14. The invention according to claim 13, wherein the audio analysis system is operable to extract qualitative data from at least one peak and valley of a sound wave amplitude so as to derive a quantitative result.

15. A data analysis and compression system, comprising:
providing a source of data, wherein the data is selected from the group consisting of sequential images, video, audio, and combinations thereof;
designating a master image from the sequential images;
determining whether a first sequential image other than the master image exists;
if the first sequential image other than the master image exists, comparing the first sequential image to the master image;
creating a first new image containing any image differences between the master image and the first sequential image;
determining whether a second sequential image, other than the master image and the first sequential image, exists;
if the second sequential image, other than the master image and the first sequential image, exists, comparing the second sequential image to the master image;
creating a second new image containing any image differences between the master image and the second sequential image;
determining whether a third sequential image, other than the master image, the first sequential image, and the second sequential image, exists; and
compiling the master image, the first new image, and the second new image in a sequence.

16. The invention according to claim 15, wherein the video is converted into a series of sequential images.

17. The invention according to claim 16, further comprising;
designating a master image from the series of sequential images;
comparing one of the series of sequential images to the master image;
creating a new image containing any image differences between the master image and one of the series of sequential images; and
compiling the master image and the new image in a sequence.

18. The invention according to claim 17, wherein the audio is combined with the master image and the new image in a video format.

19. The invention according to claim 15, wherein the audio is extracted from the source of data and stored in a data storage medium.

20. The invention according to claim 19, wherein the stored audio is analyzed by an audio analysis system.

21. The invention according to claim 20, wherein the audio analysis system is operable to extract qualitative data from at least one peak and valley of a sound wave amplitude so as to derive a quantitative result.
